(19) United States
(12) Patent Application Publication
(10) Pub. No.: US 2017/0103463 A1
(43) Pub. Date: Apr. 13, 2017

(54) SYSTEM, APPARATUS AND METHODS FOR OBSERVING, INTERACTING WITH AND TESTING A VIRTUAL MARKET

(71) Applicant: THE TRUSTEES OF THE STEVENS INSTITUTE OF TECHNOLOGY, Hoboken, NJ (US)

(72) Inventors: Ionut Florescu, Hoboken, NJ (US); Dragos Bozdog, Astoria, NY (US); Jinyu Zeng, Jersey City, NJ (US); Ziwen Ye, Jersey City, NJ (US); George Calhoun, New York, NY (US)

(73) Assignee: THE TRUSTEES OF THE STEVENS INSTITUTE OF TECHNOLOGY, Hoboken, NJ (US)

(21) Appl. No.: 15/288,467

(22) Filed: Oct. 7, 2016

Related U.S. Application Data
(60) Provisional application No. 62/239,351, filed on Oct. 9, 2015.

(51) Int. Cl. G06Q 40/04; G06Q 10/08; G06Q 30/02

(52) U.S. Cl. CPC G06Q 40/04; G06Q 30/0201; G06Q 10/087

(57) ABSTRACT

An apparatus and method for modeling, interacting with and testing market behavior has a system defining a virtual market that may be used to study and test algorithmic trading and market behavior at the microstructure level. The system may use real data and time sequences and features a trading mechanism implemented by a database server, an information center, client computers and a matching engine through which a live stream of orders is matched against a static historical stream of orders. In one embodiment, the system uses real servers on a real network with inherent latency.

### CROSS-REFERENCE TO RELATED APPLICATIONS

This application claims the benefit of U.S. Provisional Application No. 62/239,351, filed Oct. 9, 2015, entitled, SYSTEM, APPARATUS AND METHODS FOR OBSERVING, INTERACTING WITH AND TESTING VIRTUAL MARKET, which application is incorporated by reference herein in its entirety.

### FIELD

The present invention relates to financial market simulators, and more particularly, to a simulator for research and for training persons with an interest in learning the operation of financial markets and observing impacts of trading practices on financial markets.

### BACKGROUND

Theories of stochastic processes, e.g., as exemplified by market behavior (stock, commodity, currency, derivatives, etc.) are often expressed in terms of possible alternative paths starting with today's observation. When these theories are applied to finance, the problem of the “one reality” is encountered. More specifically, the market only has one reality, that is, the traded price at each time t, and there is really no alternative to the actual trading record. To deal with this problem, mathematicians invoke hypotheses such as homogeneity, self-similarity, identically distributed increments, and the like that allow them to model multiple days of experience or empirical data as replications of the same reality of an exemplary or sample day. Market simulators are known that allow limited back-testing of a single trading strategy against recorded past data. In real life however, no day is the same as the previous one, representing a challenge for creating a realistic market simulator. In addition to this challenge with respect to modeling traditional market behavior, todays markets feature innovations, such as algorithmic and high frequency trading, which complicate efforts to model market behavior. Improved and/or alternative market modeling approaches therefore remain desirable.

### SUMMARY

The disclosed subject matter relates to a market modeling system, apparatus and method.

In one embodiment, the system may be used as an educational and research tool to observe and interact with market behavior.

In another embodiment, the components of the system are modular.

In another embodiment, the components of the system integrate with one another in a modular fashion.

In another embodiment, the system may be used to observe, interact with, study and test high frequency trading.

In another embodiment, the system may be used to observe, interact with, study and test algorithmic trading.

In another embodiment, the system may be used to observe, interact with, study and test market behavior at the microstructure level.

In another embodiment, the system may be used to observe, interact with, study and test market behavior corresponding to market crashes.

In another embodiment, the system may be used to observe, interact with, study and test market behavior using real data and time sequences instead of simulated data.

In another embodiment, the system may be used to observe, interact with, study and test market behavior as a platform to learn coding.

In another embodiment, the system may be used to observe, interact with, study and test market behavior as a platform to apply theoretical methods and to simulate markets with real data.

In another embodiment, the system includes a trading mechanism implemented by a database server, an information center, client computers and a matching engine.

In another embodiment, a live stream of orders is matched against a static historical stream of orders.

In another embodiment, the system uses real servers on a real network with inherent latency.

In another embodiment a simulation apparatus includes a source of a stream of digital market data from a trading market for items for a time period T, including data identifying the items and associated price data, the stream of data defining a portion of a dynamic virtual market; a user computer capable of receiving the digital market data from the source of digital market data and displaying at least a portion of the data to a user on the user computer, the user computer capable displaying a graphical user interface for receiving input from the user defining orders for items on the virtual market based upon order data entered by a user into the user computer; and a matching engine capable of receiving the orders for items entered by the user and fulfilling orders from the virtual market, the matching engine changing the market data to reflect the fulfillment of the order, the user computer capable of displaying at least a portion of the changed market data to the user, the user activity and the matching engine comprising other portions of the virtual market.

In another embodiment, the source of the stream of data is a database server computer.

In another embodiment, the stream of data for time period T is historical data recorded from a real trading market.

In another embodiment, the changing of the market data is conducted using mathematical rules operating on the stream of market data to simulate the reaction of a real market to fulfillment of the order placed by the user.

In another embodiment, further including an information center data server serving data concerning items on the market, the user computer connected to the information center data server and capable of displaying the information on the items to the user.

In another embodiment, the information center data center server also provides analysis programs to the user for conducting analysis on the market data.

In another embodiment, the stream of data is obtained from a real trading market and delayed by a delay time T_{D}.

In another embodiment, further including a source of a stream of digital market data from a real trading market in real time.

In another embodiment, the source of the stream of market data is capable of replaying the historical data at a plurality of speeds.

In another embodiment, the database server computer provides analytic tools to the user computer.

In another embodiment, the analytical tools include at least one of moving averages, standard deviations, and momentum indicators.

In another embodiment, the fulfillment of an order is recorded and accessible to a user for viewing a history of orders made by the user.

In another embodiment, the database server is capable of altering the stream of market data to impose a factor other than the placement of an order by the user.

In another embodiment, a user may place orders via a trading algorithm. In another embodiment, the factor imposed on the stream of market data is imposed for the purpose of stress testing a trading algorithm.

In another embodiment, further including an information center data server serving data concerning the user and orders placed by the user, the user computer connected to the information center data server and capable of displaying the information on the orders to the user.

In another embodiment, further including a source of trading rules that are imposed on user when placing orders.

In another embodiment, the apparatus is connected to a plurality of users and is capable of receiving orders from a plurality of users and implementing an order fulfillment priority rule.

In another embodiment, the matching engine servers are capable of applying regulatory trading rules.

In another embodiment, the trading algorithm executes high frequency trading.

### BRIEF DESCRIPTION OF THE DRAWINGS

For a more complete understanding of the present disclosure, reference is made to the following detailed description of exemplary embodiments considered in conjunction with the accompanying drawings.

FIG. 1 is schematic diagram of a system, apparatus and method for modeling a market in accordance with an embodiment of the present disclosure.

FIG. 2 is a screen shot of a user interface window in accordance with an embodiment of the present disclosure, namely, a client interface window providing a connection with the matching engine and apparatus governing trades.

FIG. 3 is a screen shot of a user interface window in accordance with an embodiment of the present disclosure, which displays the activity of the global market (feed or simulated data)

FIG. 4 is a screen shot of a user interface window in accordance with an embodiment of the present disclosure, which displays the activity of the local market composed of the system's clients.

FIG. 5 is a screen shot of a user interface window in accordance with an embodiment of the present disclosure, which displays an embodiment of the client's risk management interface.

FIG. 6 is schematic diagram of a system, apparatus and method for modeling a market in accordance with an alternative embodiment of the present disclosure.

### DETAILED DESCRIPTION OF EXEMPLARY EMBODIMENTS

An aspect of the present disclosure is the recognition that a system which allows a researcher to observe the effects of the interaction of multiple strategies running in real time would be desirable. Another aspect of the present disclosure is a market modeling system that uses real servers on a real network and having inherent latency. A system of this type allows the study of the issues that may arise in a real exchange without analyzing and experimenting on a real exchange.

As to the problem of the “one reality,” i.e., that there is, apparently, no alternative to an actual trading environment, the present disclosure may supersede this theoretical limitation. An aspect of the present disclosure is the creation of an alternative market, which allows study of intensive and unusual market activity, e.g., a scenario of events during the most studied day for high frequency trading: Mar. 6, 2010 (the flash crash), if there were four high frequency traders operating in E-Mini (instead of three traders as it was in reality). The present disclosure relates to a system that may be used to test and observe market response to rules, e.g., a regulation that would have prevented traders on Mar. 6, 2010 from selling shares of the stock as soon as they got them.

Modeling the behavior of 10,000 trading entities is an immense task, which is why the system of the present disclosure is not simply an exchange simulator. In accordance with an embodiment of the present disclosure, the system comes with a client side, which allows a user to design strategies without worrying about links, risk management, P&L, GUI or indeed any of the components that are common to all strategies. An aspect of the system of the present disclosure is the ability to replicate one or more trading strategies multiple times, e.g., 10,000 times (which is what most market simulators do), but also to model the impact of multiple complex strategies operating in a market simultaneously. High Frequency data presents new and complex challenges and, to Applicant's knowledge, no algorithm or charting method has been developed for intraday or daily trading that works in the context of HF data. Models applicable to HF data are different from models for hourly, or daily trading data. An aspect of the present disclosure is to provide a system that bridges the gap that exists between market microstructure finance and macroeconomic finance, in effect correlating micro dynamics (data sampled with high frequency) with macro effects.

In one embodiment, the system may be used as an educational and research tool to observe and interact with market behavior. The hardware and software components of the system may be modular and may integrate with one another in a modular fashion. The system may be used to observe, interact with, study and test high frequency (HF) trading and algorithmic trading. The system may be used to observe, interact with, study and test market behavior at the microstructure level and to model and test market behavior corresponding to market crashes using real data and time sequences instead of simulated data. In one aspect, the system may be used as a platform to learn software coding for market analysis or participation, e.g., algorithmic trading. The system may be used as a platform to apply theoretical methods to simulate markets with real data. The system may include a trading mechanism implemented by a matching engine, including a matching engine through which a live stream of orders is matched against a static historical stream of orders. In one embodiment, the system uses real servers on a real network with inherent latency.

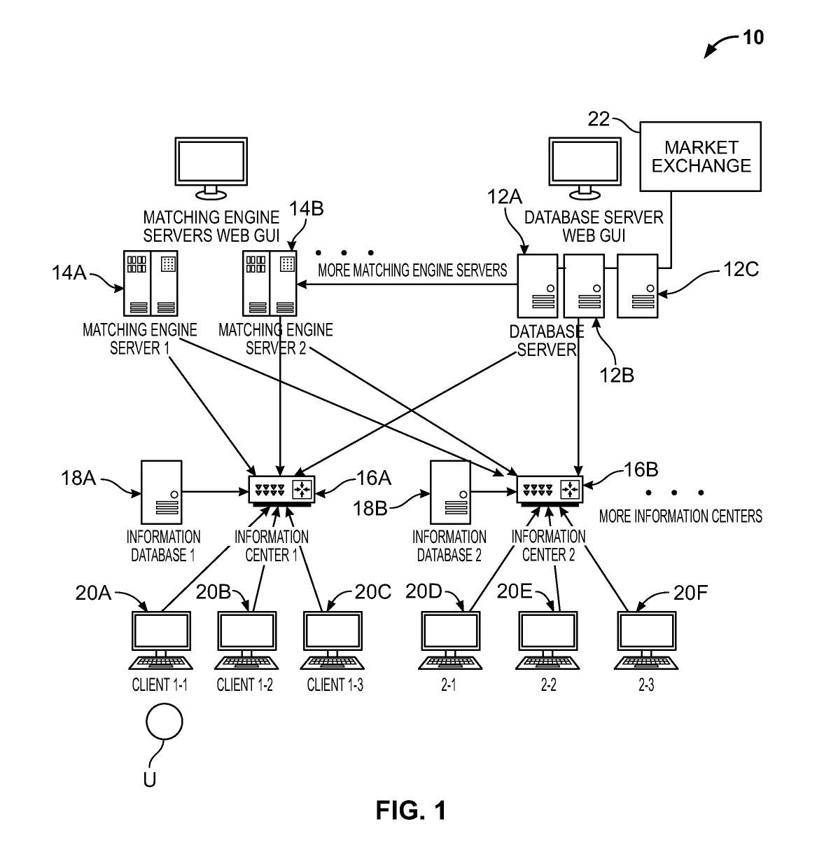

FIG. 1 shows a system 10 having one or more database servers 12A-12C that manage financial instruments history data. One or more matching engine servers 14A, 14B match orders from a market database available to the database servers 12A-12C and one or more information centers 16A, 16B. One or more information databases 18A, 18B that communicate with the information centers 16A, 16B manage client side data and system messages. The information centers 16A, 16B transmit information and route orders. One or more clients 20A-20F connect to an information center 16A, 16B to access a program residing thereon that allows a user to conduct trading and analysis.

The database servers 12A-12C are capable of sending any given volume of historical data or delayed real time data from any source to the matching engine servers 14A, 14B, to the information centers 16A, 16B, as well as to any/all clients 20A-F in the system 10. The database servers 12A-12C have the capability of playing real time data by connecting to any market exchange 22. The database servers 12A-12C require a dedicated or virtual server to have all the functionality described herein. While the database servers 12A-12C may run together with all other components on the same server, functionality may be reduced. The database servers 12A-12C are synchronized with the matching engine servers 14A, 14B in terms of time and data and periodically send historical data to the matching engine servers 14A, 14B for matching trades purposes.

The database servers 12A-12C may store data in a SQL type database, or a file based database and have the capability to adjust the record times to the current time when the system 10 is started. The database servers 12A-12C can replay historical data as if it is current data and replay data at different speeds from the real, recorded historical data timestamp. Multipliers may be employed to adjust the replay speed, varying from 0.1 to 5.0 times the real speed. The database servers 12A-12C store records of all trades executed on the system 10 and provide analytical tools (pre-computed statistics e.g., moving averages, standard deviations, momentum indicators) for back testing purposes to all the clients 20A-20F in the system 10. The database servers 12A-12C can provide reports of the trading activity to all clients 20A-20F in the system 10 as well for the trading activity of researchers and students. The database servers 12A-12C have the capability to alter the original market data to create alternative scenarios and to simulate stock movement that causes stresses in the market and forces the market participants/clients 20A-20F to stress test their algorithms. The database servers 12A-12C have a web-based GUI that allows the instantiation of the system with desired parameters. In one embodiment, the data communication between database servers 12A-12C and other components uses the QuickFix protocol or another socket communication protocol.

The information centers 16A, 16B and information center databases 18A, 18B allow users to authenticate their identity and authorization to use the system 10 so that they can send orders through the system 10 and connect to all other components by storing account credentials of all clients 20A-20F connected to it. The information center databases 18A, 18B store order records (these are orders sent and listed in the matching engine servers 14A, 14B order book), execution records for all clients connected to it, canceled quotes records, as well as the amount of cash in the account of every client 20A-20F. It can make available client records to the respective interested client 20A-20F. The information centers 16A, 16B re-broadcast market data to all connected clients 20A-20F by offering subscriptions for clients 20A-20F to receive updates of the financial instrument order book in a specific matching engine server 14A, 14B, and also the whole order book if required. The information centers' 16A, 16B server relays orders to the matching engine server 14A, 14B using its own identifier and it is the entity which can identify the owner of every order sent through it. The information centers 16A, 16B broadcast execution records to relevant clients 20A-20F. The information center databases 18A, 18B have set margin requirements for each client 20A-20F, and the information centers' 16A, 16B engines enforce these requirements. The information centers 16A, 16B allow clients 20A-20F to perform short selling by loaning them needed stock for a trading fee. The information centers 16A, 16B have a mechanism to impose rules so that clients 20A-20F are in compliance with the market regulations. The information centers 16A, 16B keep records of each clients' 20A-20F performance in a given trading experiment and can be used to provide statistics of performance comparison between clients 20A-20F. The information centers 16A, 16B serve as information backup for clients 20A-20F, will automatically resend and synchronize the information after a client's system goes down and insures information accuracy and consistency if network error occurs. The information centers 16A, 16B can connect clients 20A-20F with multiple matching engine servers 14A, 14B and can route all messages to the appropriate receiver. Data communication between the information centers 16A, 16B and other components of the system 10 may use the QuickFix protocol or other socket communication protocols.

The matching engine servers 14A, 14B have input windows to decide what instruments, dates and time period to execute a virtual or experimental trade or other market action. The rate of time progression for the system 10 can also be set. In one example, trading parameters could be specified as: stocks: JPM, IBM; date: 2015 Apr. 10 to 2015 Apr. 29; time period: 09:30:00 to 16:00:00. Order types for stocks can be limit buy, limit sell, market buy, market sell and cancel order. Any other complex order type may be decomposed into these basic order types. A primary role of the matching engine servers 14A, 14B is to match orders from the database servers 12A-12C and orders received from information centers 16A, 16B. Orders from database servers 12A-12C may be used to construct a global order book. Orders from information centers 16A, 16B may be used to construct a local order book. Order flow first goes into the local order book to find matches and then to the global order book. The database servers 12A-12C order flow has an impact on the local order book, by trading with the local order book listed orders if it provides a better price. The trading order prioritizes the orders received from information centers 16A, 16B. Orders may be sorted based on the time sequence they are received by the matching engines 14A, 14B. One approach is to use a rule of first come, first matched, however other rules may be implemented on the matching engine servers 14A, 14B. In one example, a rule may specify that during a given time period of, e.g., 3 seconds, orders received during this period are sorted in price sequence, then the orders with the best price are matched first and so on. After another 3 seconds, the next batch of orders received is processed. The administrator of the system 10 can select which rule to apply. The matching engine servers 14A, 14B can apply market regulations, e.g., ban short order on stocks when price decreases more than 10%. An option may be provided for activating each of the rules existing in the matching engine servers 14A, 14B. A timestamp will be provided according to the date, time and speed when new orders are received from the information centers 16A, 16B. A confirmation message is sent to the specific information center. This confirmation message rule applies to execution reports for both information centers 16A, 16B and database servers 12A-12C. Multiple matching engine servers 14A, 14B may run independently on multi-cores or multi-servers connected by information centers 16A, 16B to clients 20A-20F. The data communication between matching engine servers 14A, 14B and other components of the system 10 may use the QuickFix protocol, as well as other socket communication protocols. The matching engine servers 14A, 14B have a web based GUI that allows the instantiation of the system 10 with desired parameters.

Clients 20A-20F may be used to create accounts for traders with an identity request and cash initiation request. Upon entry of an authorized user U into the system 10, i.e., via a client 20A-20F, the client, e.g., 20A may request history data from a database server, e.g., 12A pertaining to the user U. The user U may then select an analysis tool on database server 12A and request a result. The user U may get an update of a selected order book and also news from an information center, e.g., 16A. The user U may receive real time feedback of order status from the information center 16A (confirmed, listed, executed, canceled). The user U may send new orders to a matching engine server, e.g., 14A manually and/or apply electronic trading algorithms. The user U may request records of listed, traded, and canceled orders from the information center 16A and utilize tools to give charts, pictures or signals to analyze real time trading information from the information center 16A. The system 10 may provide P&L tables and other trading performance reports, including risk management for trading activities to the user U.

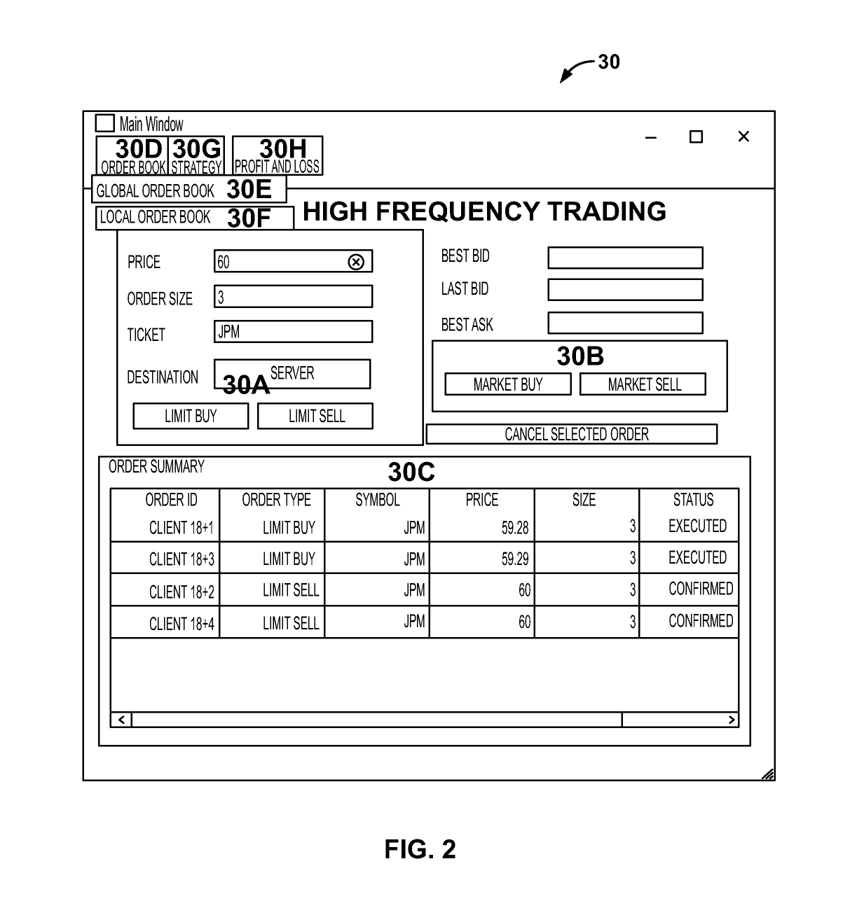

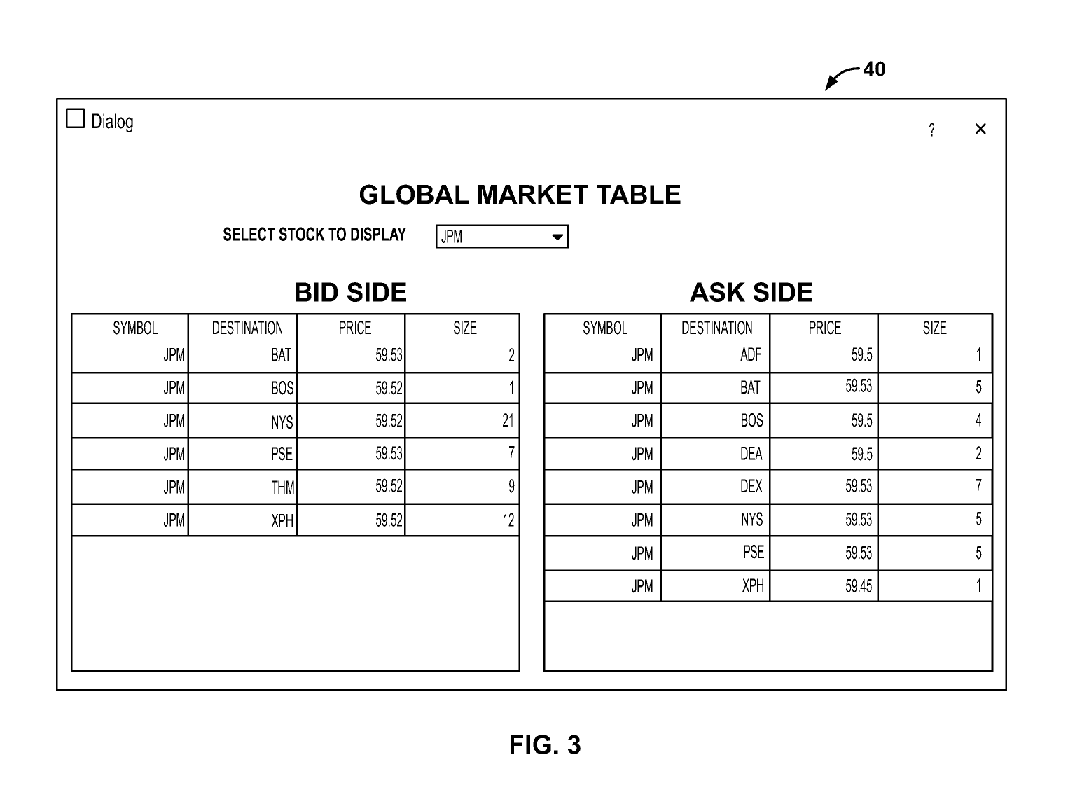

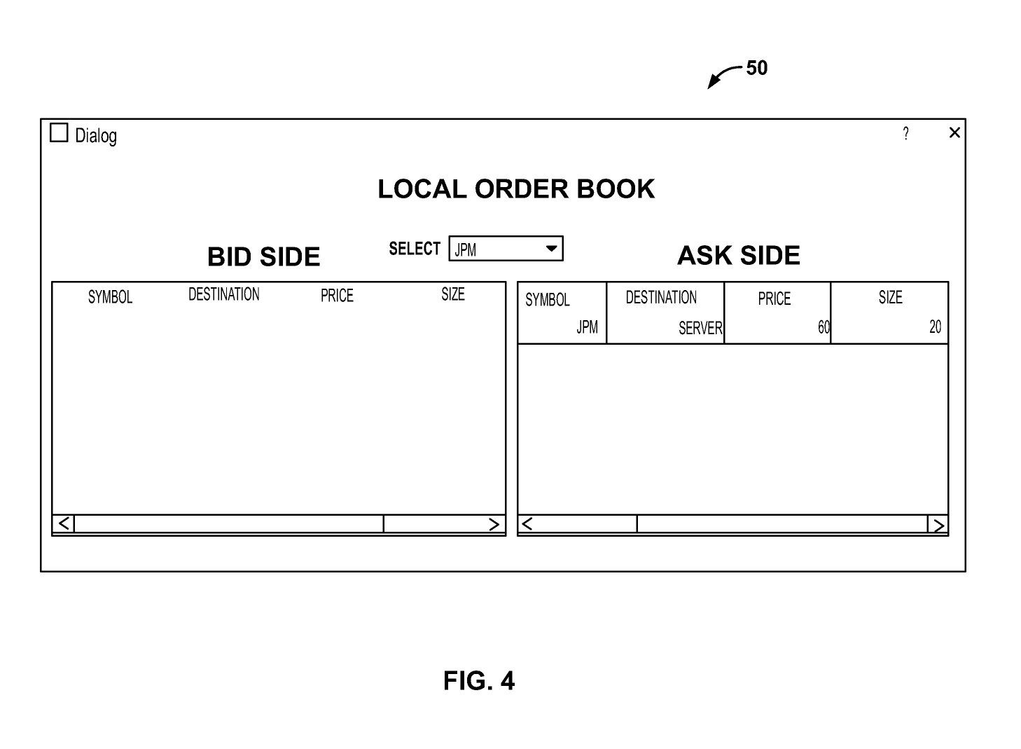

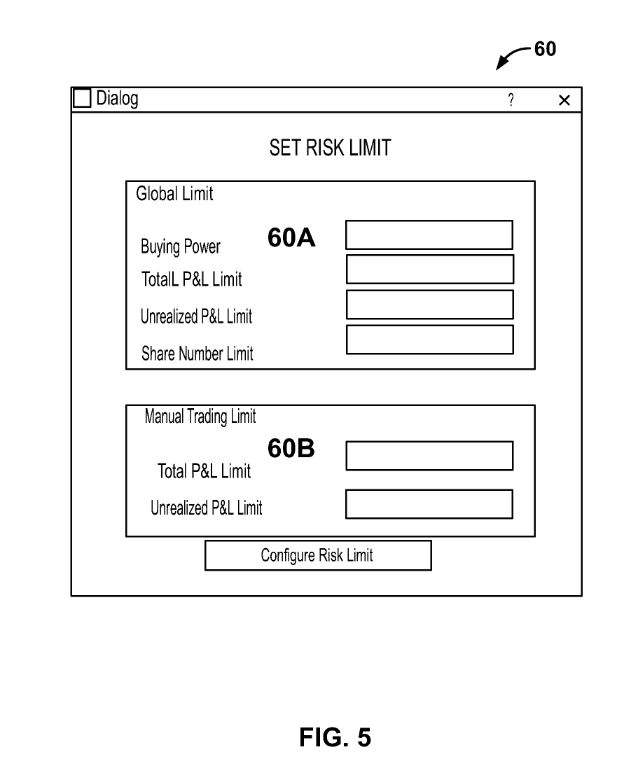

FIG. 2 shows an embodiment of a client interface window 30. The key elements present in such embodiment are the limit order submission interface 30A, the market order submission interface 30B, and the order status information window 30C. The client interface window 30 opens various other informational and interface windows through the buttons on the top 30D. The button 30E opens the Global Market information window 40 presented in FIG. 3. The button 30F opens the Local Market information window 50 presented in FIG. 4. The button 30G opens various strategies windows. The window sequence traversed by activation of buttons 30D, 30E, etc. can be controlled by the user. The button 30H opens an interface 60 to the risk management component where constraints on the maximum amount spent by the account may be imposed. This interface is described in FIG. 5.

The order status information window 30C displays the status of various orders sent by the client to the Information Center (16A in FIG. 1). Specifically, coding Limit Buy, Limit Sell and others signify the type of order sent. The status Confirmed means that the order was sent and is in the order book on the server, the status Executed means that the order was executed and a trade is in place, and the status Canceled means that the order was canceled by the user.

FIG. 3 and FIG. 4 show window displays 40, 50 that are for informational purposes and contain details of the status of the two order books that can be created at any moment in time. The user has the capability to click any one of the orders displayed and trade with it automatically.

FIG. 5 contains the interface 60 through which the strategy's risk limits may be set. The set of attributes in the Global Limit section 60A of the Risk Management interface 60 specify limits for the account. These limits apply to the performance of all the strategies' combined performance. The set of attributes in 60B apply to each specific strategy. Multiple windows will appear here as new strategies are started by the user.

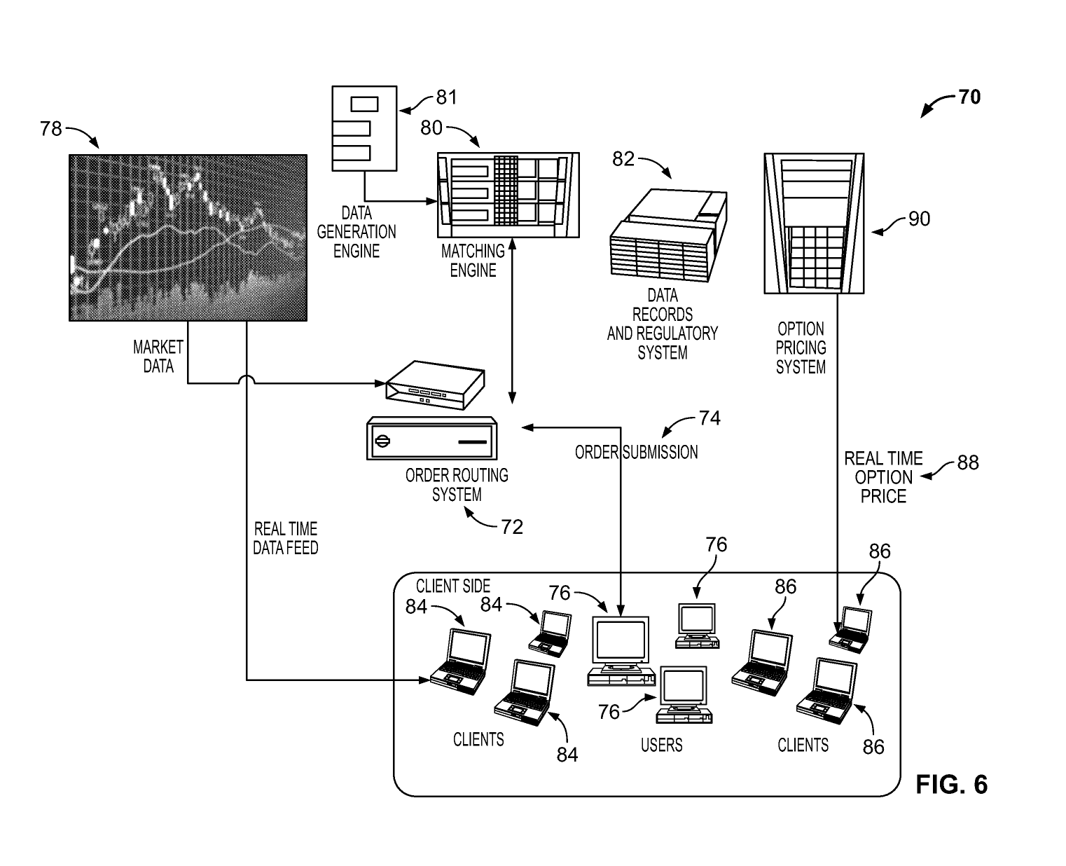

FIG. 6 shows a system 70 having an order routing system 72 that receives orders 74 sent by one or more users 76 (users acting through computer connected to the order routing system, e.g., via a network). The order routing system 72 accesses market data 78 and a matching engine 80 coupled to a data generation engine 81 to fulfill orders under the constraints of stored data records and a regulatory system 82. Client computers 84 can monitor the market data over time. Client computers 86 monitor a real time option price 88 provided by an option pricing system 90. Multiple matching engines 80 may be utilized in different instruments, e.g., futures, FX rates, options, CDS, etc. The option pricing system 90 may be used to guide investors, traders and students. The system 70 may be utilized to implement, test and monitor multiple trading strategies.

Aspects of the present disclosed system include: A complete functional back end containing: a matching engine and a data generation engine. Three types of front end client software are available, viz., a self-deployable local GUI interface (Windows program), a command line interface and a Web interface (html5).

The disclosed system can feature the following features: a) replay order book and tick level (and any other frequency) REAL data; b) simulate tick level and order book data; c) incorporate news and have news and market dynamics interrelate; d) it can be used for any market whatsoever (equity, futures, commodities, FOREX, options, ETF, CDS etc.); e) It allows users to interact and influence each other trading decisions; f) It can incorporate new market rules and thus study them before implementation.

The systems 10, 70 of the present disclosure is designed to be very versatile and can have multiple configurations deployed. Primary application areas include: a) teaching, e.g., Microstructure finance and Algorithmic trading courses; b) Industry, e.g., designing and back testing high frequency trading algorithms in a realistic environment; c) research, e.g., answering research questions about the impact and interaction of HFT algorithms in the market; and government, e.g., designing and studying the impact of new regulations on financial markets. As a consequence, the disclosed system may be of interest to: a) universities, e.g., who are developing courses in Market Microstructure, as well as, very new algorithmic trading, statistical arbitrage and high frequency trading; b) researchers at universities looking to test methods in a real HF finance setting; c) government agencies looking for testing new rules; and d) financial firms testing algorithms as well as training their employees.

The systems 10, 70 of the present disclosure may be used to help students understand commodities, futures and options and how they are traded and dynamically change using a real system. In one aspect, the systems 10, 70 may be used in an algorithmic trading competition based on the platform. The systems 10, 70, may be used to design and back test algorithmic strategies as well as their impact on market behavior, for developing an understanding of and expanding the use of options and commodities in general portfolio construction. The systems 10, 70 may also be used to measure volatility on different scales and studying its dynamics and for research into the creation of liquidity indices to be used in risk management.

In the regulatory environment, the systems 10, 70 may be used to test trading rules before implementing them and/or to reach a better characterization of HFT traders through the impact they have on the market. The systems 10, 70 may be used to compare the impact on the market of regulations in different countries and jurisdictions and to study liquidity and its dynamics (potential moment indicator). New indices for risk management and subsequent creation of novel ETF's may be created. The impact of transaction taxes on trader behavior (looking at P&L) may be studied using the systems 10, 70. The systems 10, 70 may also be utilized to study the utility of FPGA and CUDA for valuation and for familiarizing and educating a workforce with CME instruments. Finally, the systems 10, 70 may be utilized to implement quantum algorithms.

It will be understood that the embodiments described herein are merely exemplary and that a person skilled in the art may make many variations and modifications without departing from the spirit and scope of the disclosed subject matter. All such variations and modifications are intended to be included within the scope of the present disclosure and claims.

We claim:

1. A simulation apparatus, comprising:
a source of a stream of digital market data from a trading market for items for a time period T, including data identifying the items and associated price data, the stream of data defining a portion of a dynamic virtual market;
a user computer capable of receiving the digital market data from the source of digital market data and displaying at least a portion of the data to a user on the user computer, the user computer capable displaying a graphical user interface for receiving input from the user defining orders for items on the virtual market based upon order data entered by a user into the user computer;
a matching engine capable of receiving the orders for items entered by the user and fulfilling orders from the virtual market, the matching engine changing the market data to reflect the fulfillment of the order, the user computer capable of displaying at least a portion of the changed market data to the user, the user activity and the matching engine comprising other portions of the virtual market.

2. The apparatus of claim 1, wherein the source of the stream of data is a database server computer.

3. The apparatus of claim 2, wherein the stream of data for time period T is historical data recorded from a real trading market.

4. The apparatus of claim 1, wherein the changing of the market data is conducted using mathematical rules operating on the stream of market data to simulate the reaction of a real market to fulfillment of the order placed by the user.

5. The apparatus of claim 1, further comprising an information center data server serving data concerning items on the market, the user computer connected to the information center data server and capable of displaying the information on the items to the user.

6. The apparatus of claim 5, wherein the information center data center server also provides analysis programs to the user for conducting analysis on the market data.

7. The apparatus of claim 3, wherein the stream of data is obtained from a real trading market and delayed by a delay time T_{D}.

8. The apparatus of claim 3, further comprising source of a stream of digital market data from a real trading market in real time.

9. The apparatus of claim 3, wherein the source of the stream of market data is capable of replaying the historical data at a plurality of speeds.

10. The apparatus of claim 2, wherein the database server computer provides analytic tools to the user computer.

11. The apparatus of claim 10, wherein the analytical tools include at least one of moving averages, standard deviations, and momentum indicators.

12. The apparatus of claim 1, wherein the fulfillment of an order is recorded and accessible to a user for viewing a history of orders made by the user.

13. The apparatus of claim 2, wherein the database server is capable of altering the stream of market data to impose a factor other than the placement of an order by the user.

14. The apparatus of claim 1, wherein a user may place orders via a trading algorithm.

15. The apparatus of claim 13, wherein the factor imposed on the stream of market data is imposed for the purpose of stress testing a trading algorithm.

16. The apparatus of claim 1, further comprising an information center data server serving data concerning the user and orders placed by the user, the user computer connected to the information center data server and capable of displaying the information on the orders to the user.

17. The apparatus of claim 1, further comprising a source of trading rules that are imposed on user when placing orders.

18. The apparatus of claim 1, wherein the apparatus is connected to a plurality of users and is capable of receiving orders from a plurality of users and implementing an order fulfillment priority rule.

19. The apparatus of claim 1, wherein the matching engine servers are capable of applying regulatory trading rules.

20. The apparatus of claim 14, wherein the trading algorithm executes high frequency trading.
